(19) United States
(12) Patent Application Publication
(10) Pub. No.: US 2016/0316252 A1
(43) Pub. Date: Oct. 27, 2016

(54) SYSTEM, METHOD AND APPARATUS FOR ENHANCED INTERNET BROADCASTING

(71) Applicants: Greg Hendrickson, Seattle, WA (US); Stuart Strader, Olympia, WA (US)

(72) Inventors: Greg Hendrickson, Seattle, WA (US); Stuart Strader, Olympia, WA (US)

(21) Appl. No.: 14/954,692

(22) Filed: Nov. 30, 2015

Related U.S. Application Data
(63) Continuation of application No. 14/027,632, filed on Sep. 16, 2013, now abandoned.

(51) Int. Cl. H04N 21/43; H04N 21/472; H04N 21/8545; H04N 21/482; H04N 21/61; H04N 21/81

(52) U.S. Cl. CPC H04N 21/4307; H04N 21/6125; H04N 21/8146; H04N 21/8545; H04N 21/482; H04N 21/47202

(57) ABSTRACT

An internet broadcast system, method and apparatus provides a presentation tool that offers program content to viewers in a rich, interactive and exciting way while still offering the benefits of cost effectiveness, convenience, and which meets or exceeds the experience of live, in-person programming. At least two synchronized images are presented in multiple windows and an editable image selected from one of the at least two synchronized images, wherein the other of the at least two synchronized image(s) adjust to remain in sync with the edited image. A production panel includes an Administrative Section and a Viewer Section. The Administrative Section includes set of production tools which allow an administrator to create and modify programming that a viewer observes and engages with through the Viewer Section via a remote digital viewing device. Information flows between the production panel and viewing devices via the cloud-based software.

### PRIORITY CLAIM

This application claims priority to U.S. patent application Ser. No. 14/027,632 filed Sep. 16, 2013, which application claims priority to LS, Provisional Patent Application. Ser. No. 61/701,109 filed Sep. 14, 2012, both of which are hereby incorporated by reference in their entirety as if full set forth herein.

### FIELD OF THE INVENTION

The present invention relates to broadcast technology, and more specifically to internet broadcast technology.

### BACKGROUND OF THE INVENTION

In recent years, internet broadcasting, also commonly referred to as a webinar or webcast, has been adopted as a way to provide program content over the Internet more efficiently than was previously done through a physical meeting at a specific location. This concept had the eat being more economical by reducing travel budgets and eliminating the downtime people spent while traveling. However, current webcasts have earned a reputation of being boring and non-engaging, and are quite often considered by many participants to be of limited value or even a waste of time.

Most webinars and webcasts today either rely on slide presentations with voice-over or non-interactive video or rudimentary combinations of both They manage to combine the worst aspects of meetings with the worst of technology to create a dull and uninspiring presentation. Even when the topic being addressed is interesting, these stylistic and technological limitations often make such online events insufferable.

Accordingly, there is a need for an internet broadcast platform that offers program content to viewers in a rich, interactive and exciting way while still offering the benefits of cost effectiveness, convenience, and which meets or exceeds the experience of live, in-person programming.

### SUMMARY OF THE INVENTION

An Internet broadcast system, method and apparatus provides a presentation tool that provides as rich, interactive, multi-layered online experience.

An Internet broadcast system, method and apparatus is preferably cloud-based, and includes multiple-image windows and an interactive webcasting function for live or on-demand programming. The live or on-demand programming provides a dynamic presentation that is editable in real time during a live program or in post-production for on-demand programming.

An internet broadcast system, method and apparatus provides content in multiple windows that are synchronized allowing a first file associated with the content of one window to be edited while as second file associated with the content in the window adjusts to remain in sync with the edited first file.

An internet broadcast system, method and apparatus having scalable technology that allows for recording of assets, nondestructive editing, and the ability to add, delete and edit interactive elements in program post production.

### BRIEF DESCRIPTION OF THE DRAWINGS

Preferred and alternative examples of the present invention are described in detail below with reference to the following drawings:

FIG. 1 is a schematic diagram of an internet broadcast platform according to the present invention;

FIG. 2 is a schematic diagram of an Administrative Section of the platform of FIG. 1;

FIG. 3 is a schematic diagram of a Switchboard feature of the Administrative Section of FIG. 2;

FIG. 4 is a screenshot of a portion of one embodiment of an Administrative Section illustrating dual program windows;

FIG. 5 is a screenshot of a portion of one embodiment of Administrative Section illustrating a tray including various assets;

FIG. 6 is yet another screenshot of a portion of one embodiment of Administrative Section illustrating dual program windows;

FIG. 7 is screenshot of a portion of one embodiment of Administrative Section illustrating a drag and drop feature involving program assets;

FIG. 8 is a screenshot illustrating viewer interactive features, such as chatting (texting with others) or asking questions to an administrator or moderator; and,

FIG. 9 is a screenshot illustrating yet another interactive feature, such as polling of viewers.

### DETAILED DESCRIPTION OF THE PREFERRED EMBODIMENT

A platform and production process (hereinafter the “platform”) that offers a rich, virtual experience for Internet broadcast attendees is described below. In accordance with a preferred embodiment of the present invention, the platform provides an Internet broadcast that is a multi-layered, interactive program experience capable of offering, the excitement and level of engagement that participants experience when in-person and on-site for a live presentation. As will be discussed more fully below, the platform of the present invention provides a broadcast that goes beyond what audience members may experience in-person and on-site of the presentation. The presentation includes one or more features, which may include by way of example without limitation: multiple live camera sources and/or prerecorded video; injected information from complimentary websites; tools for communicating or otherwise interacting with a presenter, administrator or other viewers; frequently asked questions; polling; and on-line document dissemination.

Internet broadcasts using the platform according to the present invention may be utilized and implemented efficiently and effectively in a variety of applications and environments, including, for example, customer meetings, multiple languages, distance learning, customer feedback retreats & meetings, new product launches, customer support, corporate training, crisis management, virtual conferences and other virtual events, and compliance training.

As will be discussed and illustrated more completely below, the platform comprises a set of tools in interactive presentation software. The platform is preferably cloud based, and according to a preferred embodiment, includes a dual (2)-screen interactive webcasting service that delivers high quality video in as live or on-demand format. It is to be understood that other embodiments may include more than two (2) screens or image windows on a digital viewing device. The dual video screens (hereinafter “windows”) preferably dynamically resize and reposition on any digital viewing device, such as a PC, laptop or tablet. As a way to further enrich the participant's experience, viewers may ask questions, complete polls or tests and access a chat feature that allows them talk with a program administrator or other viewers.

The platform preferably runs in an Internet browser and therefore does not require complicated software downloads or special equipment. In addition, the platform requires very little training and minimal prior production experience in order to be used effectively. Still further, because in a preferred embodiment the platform is cloud-based, updates and new releases may be added and easily implemented.

Preferably, the cloud-based platform is hosted in a secure, commercially available web service. As a result, users that produce Internet broadcasts using the platform of the present invention are not required to maintain servers, purchase dedicated hardware or manage a costly network infrastructure in order to do so. Furthermore, unlike a downloadable application (or app), the user does not need to download large files or follow complicated procedures to access the cloud-based platform. Also, the user need not worry about whether her/his version is current as is the case with apps that must be updated by the user. Instead, the user is assured that the platform he/she is using is the most current version in the cloud. As a result, the platform is cost effective and offers a high return on investment (ROI). With no special hardware to buy, learn and maintain, and no costly production studio staff required, users may use the platform to reach an audience in a very cost effective manner.

As a cloud-based service, the platform is readily scalable, enabling global reach with virtually no restrictions to the size of live or on-demand audiences. The platform provides a package for delivering engaging interactive presentations for meetings, events and training (for example). These presentations may be grouped into an integrated, intuitive channel guide to increase the ease with which programming may be saved, found and viewed by audience members (hereinafter “viewers”).

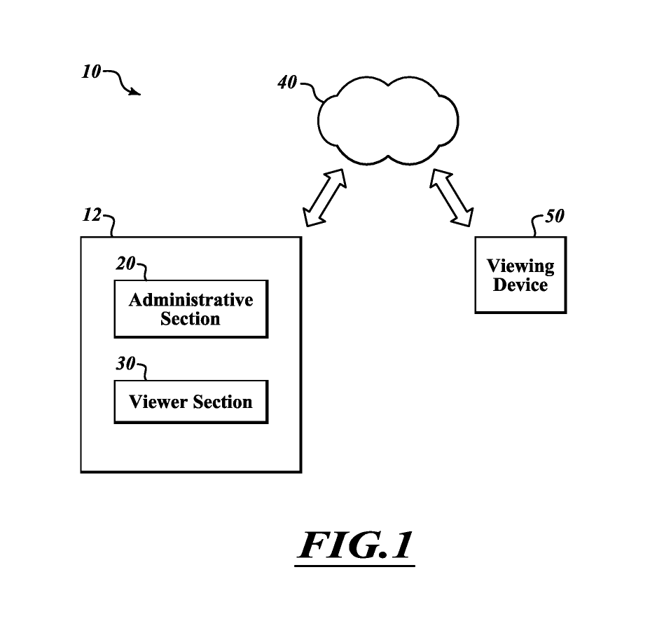

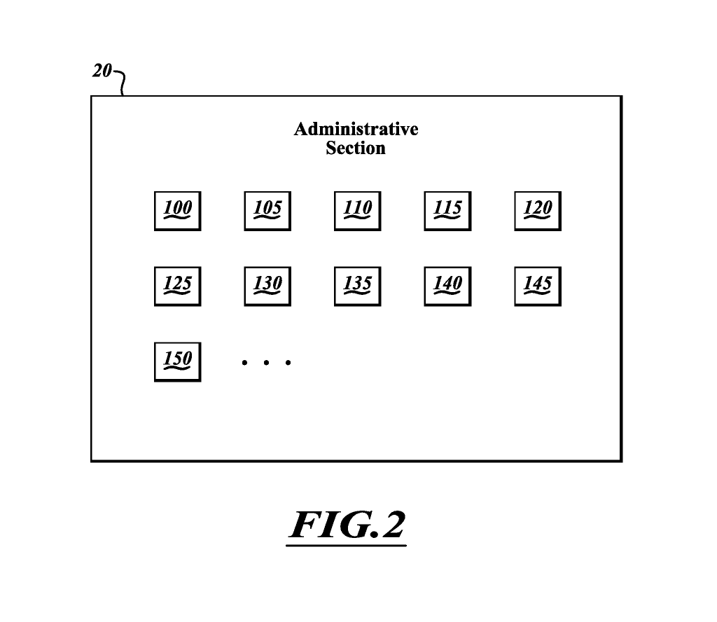

Turning now to the figures, FIG. 1 illustrates schematically a broadcast platform 10 in accordance with a preferred embodiment of the present invention, Platform 10 includes both hardware and software components. In accordance with a preferred embodiment, proprietary software 40 is cloud-based and includes web-based tools and presentation protocols suitable for creating, producing, editing and publishing interne broadcasts. Hardware includes a production panel or screen 12, such as may be found on a laptop or other computer monitor, for example. Screen 12 comprises an Administrative Section 20 and a Viewer Section 30. As is illustrated in FIG. 2 and discussed more fully below, Administrative Section 20 includes set of production tools which allow an administrator or producer (hereinafter administrator) to create and modify programming that a viewer(s) observes and engages with through the Viewer Section 30 via one or more suitable, remote digital viewing devices 50. Information flows between production panel 12 and viewing devices 50 via the cloud-based software 40.

Administrative Section 20 provides the administrator with various tools for functions, including, but not limited to: designing and publishing new programs; controlling live interactive broadcasts; conducting post-production work on programs; managing user accounts; and generating usage reports or other analytics.

In accordance with the preferred embodiment, Administrative Section 20 is the main interface for editable parameters in the broadcast program's database. As illustrated in FIG. 2, functional resources in the Administrative Section 20 are accessible to the administrator via soft keys or links to various features, functions or assets 100-150. Accessible items include, but are not limited to: Webcasts (programs) 100; Switchboard (see below 105; Polls (questions to viewers) 110; Polling Results (results of polls) 115; Incoming Questions (questions from viewers) 120; FAQs (common questions) 125; Viewers (viewer account information) 130; Channels (different programs) 135; Domains 140; Reports (analytics) 145; and Skins (appearance) 150. These functional resources are discussed in greater detail below.

Webcasts 100 allows the user to access one or more broadcast programs that she/he has been granted permission to view.

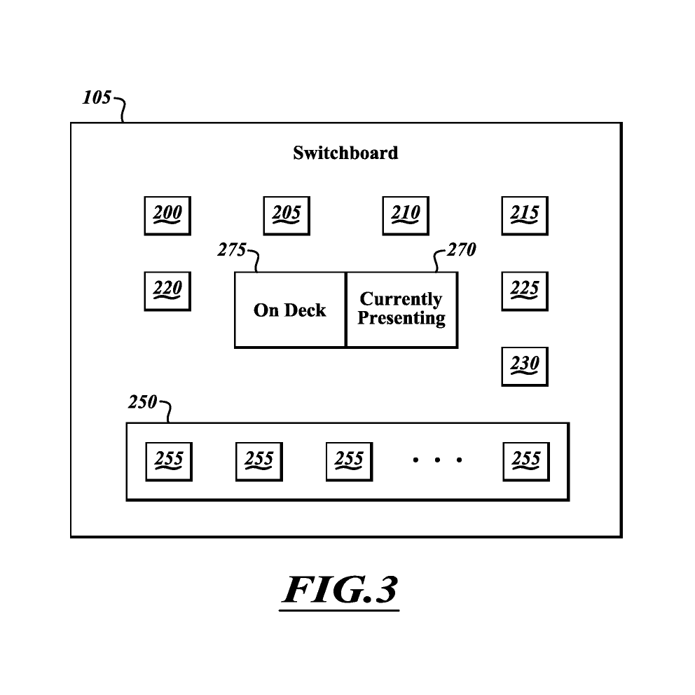

Switchboard 105 allows the administrator to perform many editing, control and monitoring functions. As illustrated in FIG. 3, these functions are preferably in the form of soft keys that link, to the various functions and may include such functionality as: Teleprompter 200 (for posing information to a presenter); Client 205 (for accessing the viewer section of the platform); and Chat 210 (for managing and monitoring communications with and between viewers); Stream 215 (for integrating live video); Post 220 (for post-production capabilities); Promotions 225 (for advertising and promoting); and Intercom 230 (for communicating with presenters).

The various features in Switchboard 105 allow the administrator to mix and compose source files in real-time and preserve the resulting files for on-demand viewing. As discussed previously, Post 220 initiates a post-production editor, which enables the administrator to adjust program compositions that were recorded during a live broadcast as well as produce on-demand programs by simply uploading, content and then composing the on-demand presentation offline. As was also introduced previously, Stream 215 preferably launches a browser-based, encoding interface that allows live video or other assets on his/her computer or tablet, such as presentation slides or photo images, to be pulled into tray 250 (discussed below) so that the administrator may incorporate these assets into a program if she/he chooses.

Administrators may access post-production resources via Post button 220. Activating the post-production function preferably changes the display in Switchboard 105 to a single screen view that includes navigation buttons to step through any previously recorded sequence of events.

Following a live broadcast, administrators may wish to edit a program's composition and alter its playback from what was recorded during the live event. For example, videos may be trimmed, removed, replaced, and re-sequenced and interactive panels (features) may be added or edited. If the post-production feature is being used in an offline production mode, the post-production interface (via soft key Post 220) provides an easy to understand method for building assets into an interactive, on-demand show. A variety of composition editing tools are available, including, but not limited to edit, delete, clear all compositions and append compositions. Chapters can also be added and edited in this view.

The promotions feature, illustrated in FIG. 3 as soft key Promotions 225, and briefly discussed above, allows the administrator to display a preset list of graphical banners or videos to the presentation attendees (viewers) for such purposes as advertising and promotion. Also, Intercom 230 is soft key or button that launches a feature allowing administrators to communicate with remote presenters via webcam and microphone. Administrators may also connect a live video feed of themselves into any active streaming presentation.

As further illustrated in FIG. 3, switchboard 105 includes an area, or tray, 250 that houses one or more assets 255 for use in a presentation. Assets 255 may include source files such as video or audio clips, photos or other images, URLs or other links, or previously recorded (On-Demand) programs. As discussed previously, assets 255 may also include live video provided via Stream 215. In order to include an asset 255 in a program, the administrator simply drags and drops the icon representing the desired asset 255 into program window 275.

In accordance with a preferred embodiment, Switchboard 105 includes two (2) program windows: a Currently Presenting window 270 and an On Deck Window 275. The particular orientation of the windows may vary from what is depicted in FIG. 3. The program that is presently being broadcast appears in the Currently Presenting window 270. The administrator may build a program off-line, or modify the program currently being broadcast by dragging and dropping assets into the On Deck window 275. The Administrator may also copy the contents of the Currently Presenting window 270 into the On Deck window 275 for editing. More specifically, an administrator creates a new program by dragging elements from tray 250 to On Deck window 275. When program is complete and ready to be sent out as part of a live broadcast, a button below on deck window 275 is clicked and that composition is broadcast and that window (275) changes to Currently Presenting window 270, On Deck window 275 then switches positions with the former Currently Presenting window 270 where the next composition may be composed.

Returning to FIG. 1, The Viewer Section 30 represents the program content that is presented to the viewer on her/his remote viewing device 50. The administrator may access the Viewer Section through Viewer button 205 (FIG. 1) and see what the viewer sees on device 50. Viewer Section 30, preferably includes one or more features, including but not limited to Chapters, About This, Document Downloads, Chat, Ask a Question, FAQs, Live Polling, Sites, Channel Guide, and possibly other or different screens and features. These various functions allow for viewer interaction with the broadcast, administrator and other viewers, to provide for a rich, interactive viewing experience.

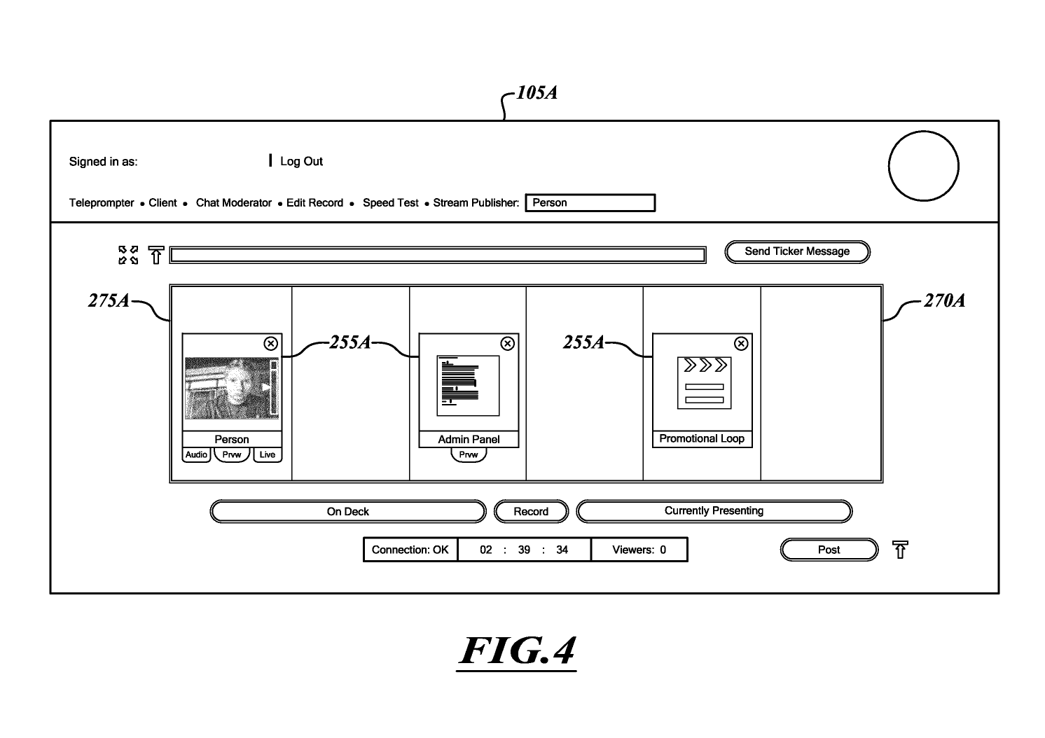

Turning next to FIGS. 4-9, screenshots of an embodiment of the present invention are illustrated. For the sake of clarity, elements that are similar to ones illustrated in the FIGS. 1-3 and discussed above are designated with similar numbers, with the addition of a letter “A”.

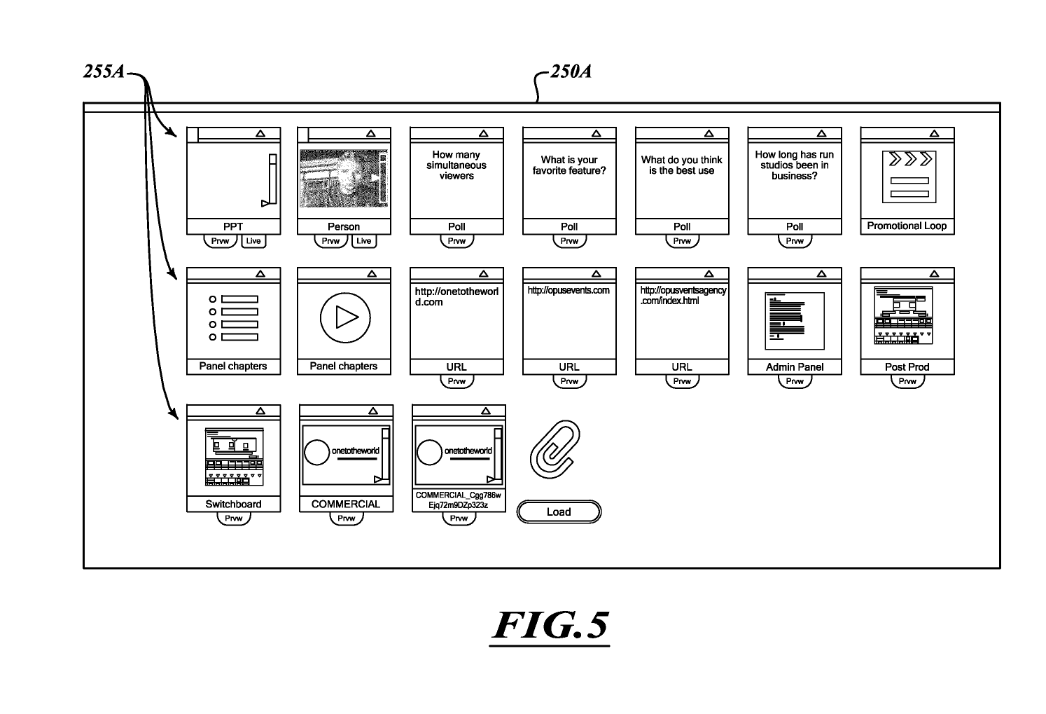

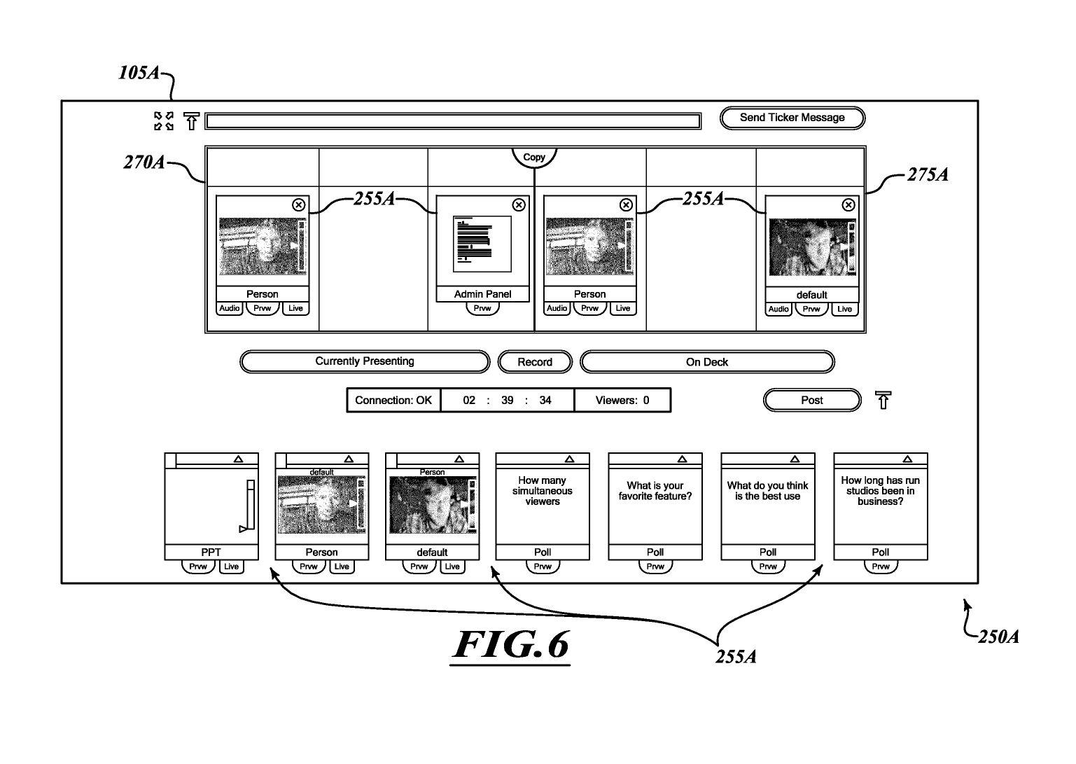

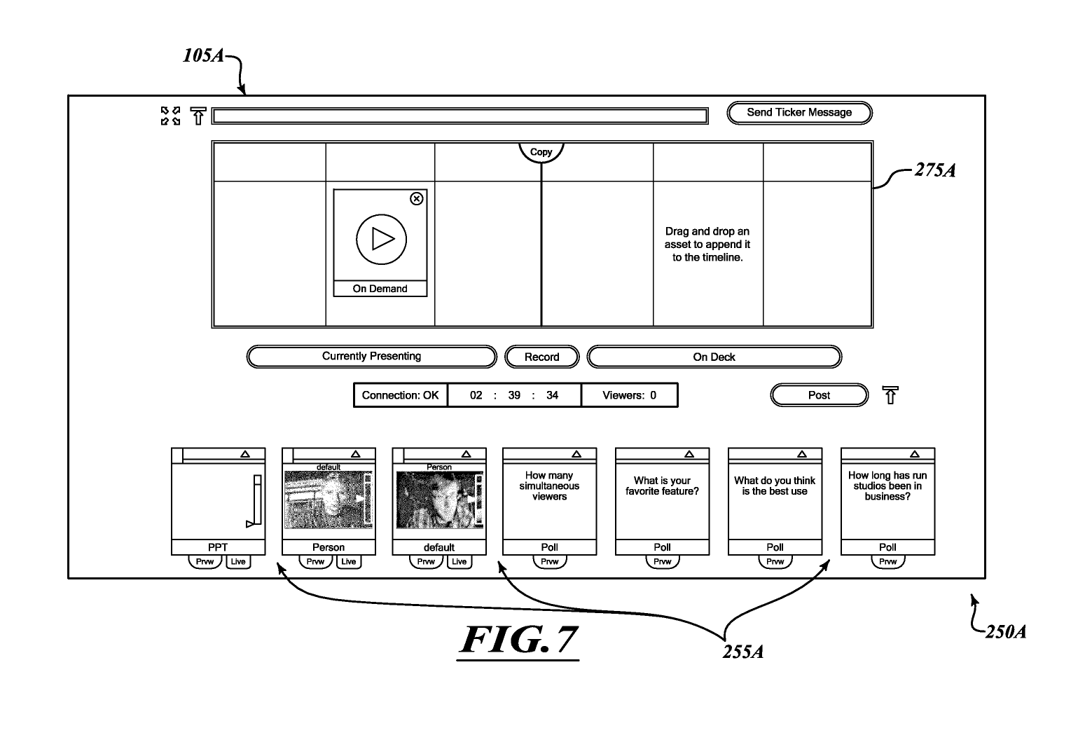

FIG. 4 illustrates dual program windows 270A, 275A and program illustrative assets 255A. FIG. 5 illustrates tray 250A with various program assets 255A that are available to the administrator for program creation and or editing, for example, FIG. 6 is another screenshot of Switchboard 105A illustrating the dual program windows 270A, 275A. The orientation of windows 270A, 275A is reversed from that illustrated in FIG. 4, which graphically illustrates how the content switches between Currently Presenting window 270A and On Deck Window 275A. FIG. 7 is a screenshot of a portion of Switchboard 105A graphically illustrating the drag and drop relationship between On Deck window 275A and program assets 255A.

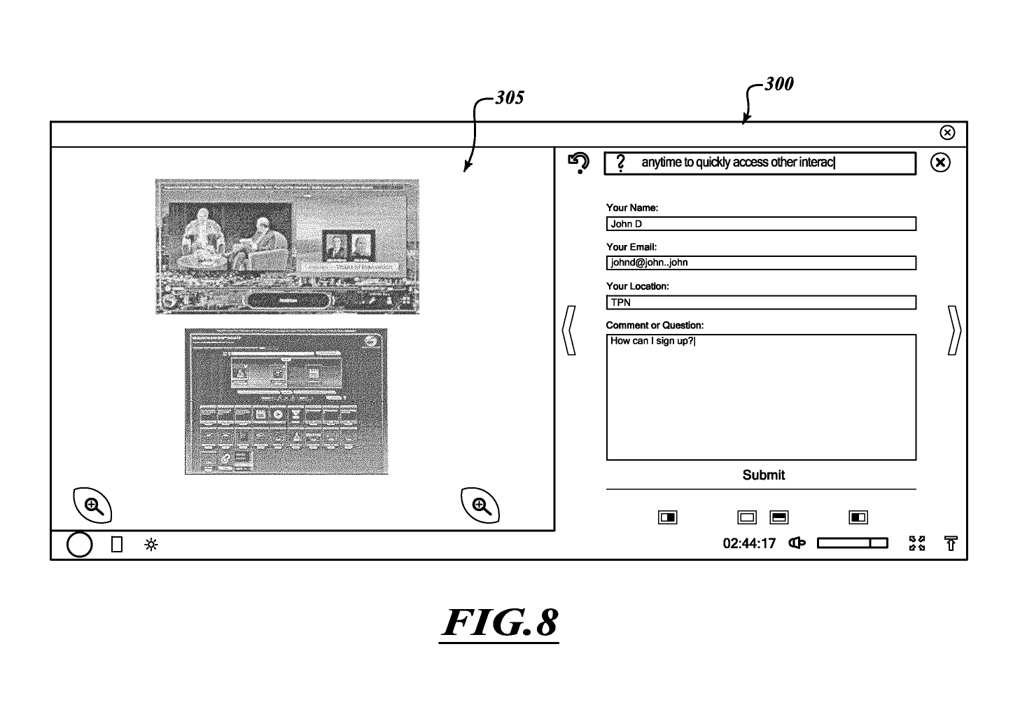

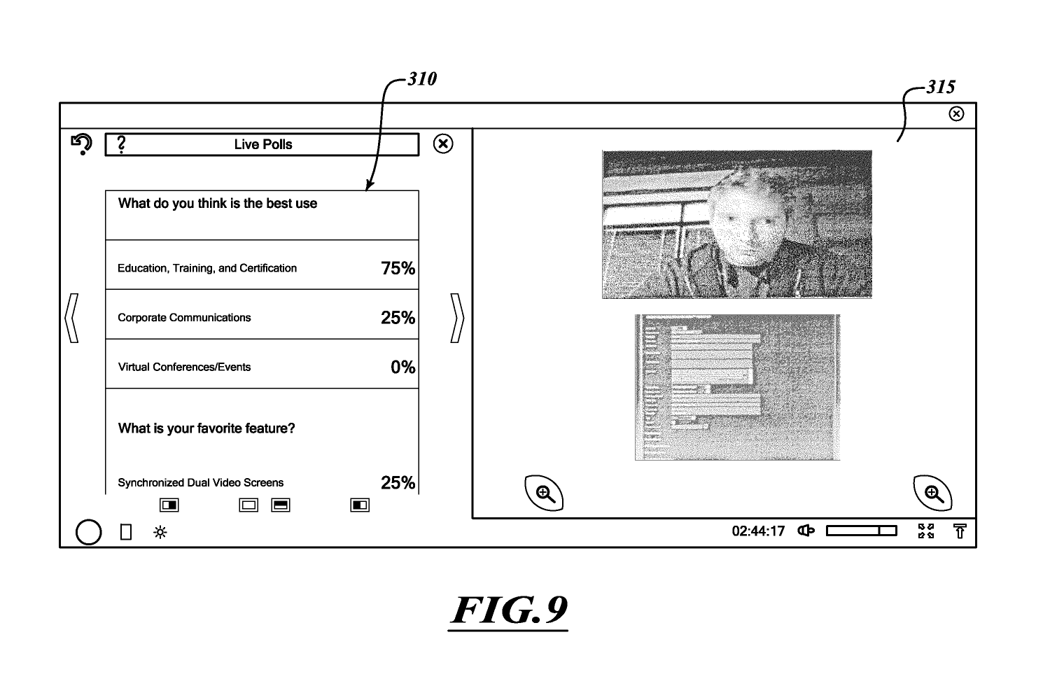

FIGS. 8 and 9 are screenshots illustrating interactive features of the broadcasting platform 10, namely viewer questioning and polling, respectively. As represented in FIG. 8, a viewer enters identifying information along with a comment or question in window 300 while the program is ongoing as depicted in window 305. FIG. 9 depicts an example of polling the audience in which questions are posed to viewers in window 310 while other program content is presented in another window 315. FIGS. 8 & 9 further illustrate the use of dual screen technology of platform 10 in accordance with the present invention.

While preferred and alternative embodiments of the invention have been illustrated and described, as noted above, many changes can be made without departing from the spirit and scope of the invention. For example, there may be more than two (2) program windows and some or all of them may be synchronized. Accordingly, the scope of the invention is not limited by the disclosure of the preferred embodiment. Instead, the invention should he determined entirely by reference to the claims that follow.

I claim:

1. An internet broadcast system, comprising:
a broadcast platform suitable for delivering programming in one of live and on-demand formats; and
a first image and a second image generated within the broadcast platform, the first image being editable and the second image adjusts to remain in sync with the editable first image.
